(19) United States
(12) Patent Application Publication
(10) Pub. No.: US 2012/0096691 A1
(43) Pub. Date: Apr. 26, 2012

(54) SELECTIVE ANGLE CLAMP APPARATUS AND SYSTEMS

(76) Inventor: Abraham Sacks, Irvine, CA (US)

(21) Appl. No.: 13/281,058

(22) Filed: Oct. 25, 2011

Related U.S. Application Data
(60) Provisional application No. 61/406,745, filed on Oct. 26, 2010.

(51) Int. Cl. F16B 2/12; F16B 2/06

(52) U.S. Cl. 24/455

(57) ABSTRACT

A first clamp device includes a first opening. A second clamp device is attached to the first clamp device. The second clamp device including a second opening. A first adjustable element is connected through the first opening. A second adjustable element is connected through the second opening.

### CROSS-REFERENCES TO RELATED APPLICATIONS

This application claims priority from U.S. provisional patent application Ser. No. 61/406,745, filed Oct. 26, 2010, incorporated herein by reference.

### BACKGROUND

1. Field

The embodiments relate to clamps, and in particular to double clamps for providing items to be joined in linear or angled arrangement.

2. Description of the Related Art

Single clamps, such as C-clamps, are used for temporary clamping multiple items together. Most single C-clamps are bulky, are not aesthetically pleasing when used in trade shows or other venues that require temporary connection of multiple items.

### SUMMARY

One embodiment of the invention provides a first clamp device including a first opening. A second clamp device is attached to the first clamp device. The second clamp device includes a second opening. A first adjustable element is connected through the first opening. A second adjustable element is connected through the second opening.

Another embodiment of the invention provides a first C-clamp device coupled with a first adjustable element. A second C-clamp device is rotatably coupled to the first C-clamp device via a hinge. The second C-clamp device is coupled with a second adjustable element.

Still another embodiment of the invention provides a first C-clamp device coupled with a first adjustable clamping element. A lockable hinge is coupled to the first C-clamp device. A second C-clamp device is coupled to the lockable hinge. The second C-clamp device is coupled with a second adjustable clamping element.

Other aspects and advantages of the present invention will become apparent from the following detailed description, which, when taken in conjunction with the drawings, illustrate by way of example the principles of the invention.

### BRIEF DESCRIPTION OF THE DRAWINGS

The embodiments are illustrated by way of example, and not by way of limitation, in the Figures of the accompanying drawings and in which like reference numerals refer to similar elements and in which:

FIG. 1 illustrates a perspective view of a fixed double clamp according to one embodiment of the invention;

FIG. 2 illustrates a panel system using the double clamp shown in FIG. 1 and a hinged double clamp according to one embodiment of the invention;

FIG. 3 illustrates a top view of a panel system using fixed and hinged double clamps according to one embodiment of the invention;

FIG. 4 illustrates an enlarged top view of a hinged double clamp and a fixed double clamp used together for connecting panels according to one embodiment of the invention;

FIG. 5 illustrates a side view of one side of a hinged double clamp according to one embodiment of the invention;

FIG. 6 illustrates a front view of a hinged double clamp according to one embodiment of the invention;

FIG. 7 illustrates a top view of a hinged double clamp according to one embodiment of the invention;

FIG. 8 illustrates an isolated view of a hinge for a double clamp according to one embodiment of the invention;

FIG. 9 illustrates a side view of a hinged double clamp using a standard clamp tightening screw according to one embodiment of the invention;

FIG. 10 illustrates a top view of a hinged double clamp according to one embodiment of the invention;

FIG. 11 illustrates a top view of a hinged double clamp shown holding panels at a right angle according to one embodiment of the invention;

FIG. 12 illustrates a top view of the hinged double clamp shown in FIG. 11 holding panels at another angle according to one embodiment of the invention;

FIG. 13 illustrates a top view of a hinged double clamp according to one embodiment of the invention;

FIG. 14 illustrates a top view of a hinged clamp shown with another clamping screw device according to one embodiment of the invention;

FIG. 15 illustrates a front view of the hinged clamp shown in FIG. 14 according to one embodiment of the invention;

FIG. 16 illustrates a rear view of the hinged clamp shown in FIG. 14 according to one embodiment of the invention;

FIG. 17 illustrates an isolated top view of a hinge according to one embodiment of the invention;

FIG. 18 illustrates an isolated front view of a hinge according to one embodiment of the invention;

FIG. 19 illustrates a perspective view of a hinged double clamp according to one embodiment of the invention;

FIG. 20 illustrates a top view of the hinged double clamp shown in FIG. 19 according to one embodiment of the invention;

FIG. 21 illustrates two panels connected together using hinged double clamps according to one embodiment of the invention;

FIG. 22A-C illustrate views of a hinged double clamp shown with a friction plate according to one embodiment of the invention;

FIG. 22D illustrates an isolated view of the friction plate shown in FIG. 22A;

FIG. 23 illustrates a front view of the hinged double clamp with a friction plate shown in FIG. 22 according to one embodiment of the invention;

FIG. 24 illustrates a perspective view of the hinged double clamp with a friction plate shown in FIG. 22D according to one embodiment of the invention;

FIG. 25 illustrates a top view of the hinged double clamp with a friction plate shown in FIG. 22D according to one embodiment of the invention;

FIG. 26 illustrates two panels connected together using hinged double clamps with friction plates according to one embodiment of the invention;

FIG. 27 illustrates an exploded view of components of an extendable clamp screw according to one embodiment of the invention;

FIG. 28 illustrates a cross section of an extendable clamp screw according to one embodiment of the invention;

FIG. 29 illustrates a top view of a hinged double clamp with clamp cups attached to extendable clamp screws according to one embodiment of the invention;

FIGS. 30A-C illustrate perspective views of fixed double clamps according to one embodiment of the invention;

FIGS. 31A-B illustrate perspective views of hinged double clamps according to one embodiment of the invention;

FIGS. 32A-D illustrate views of hinged double clamps for panels corner connecting according to one embodiment of the invention;

FIG. 33 illustrates multiple panels corner connected with hinged double clamps and other types of clamps according to one embodiment of the invention;

FIGS. 34A-C illustrate views of double clamps for joining panels horizontal to vertical according to one embodiment of the invention;

FIGS. 35A-B illustrate views of an offset double clamp with a clean inner 90 degree bend according to one embodiment of the invention;

FIGS. 36A-B illustrate views of an offset double clamp with a clean outer 90 degree bend according to one embodiment of the invention; and

FIG. 37A-B illustrate views of a friction screw for tightening hinged double clamps at particular angles according to one embodiment of the invention.

### DETAILED DESCRIPTION

The following description is made for the purpose of illustrating the general principles of the invention and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

The description may disclose several preferred embodiments of double C-clamp systems and devices, as well as operation and/or component parts thereof. While the following description will be described in terms of double C-clamp systems and devices for clarity and to place the invention in context, it should be kept in mind that the teachings herein may have broad application to all types of systems, devices and applications.

One embodiment of the invention provides a first clamp device including a first opening. A second clamp device is attached to the first clamp device. The second clamp device includes a second opening. A first adjustable element is connected through the first opening. A second adjustable element is connected through the second opening. In one example, hinged double C or U shaped clamp embodiments of the invention may be used in connecting two panels together, whether the same thickness and size or not, at any desired angle. Other uses for hinged C-clamps may include clamping signage or other items to a platform, holding objects at desired angle for hands-free usage, shelving, join panels together to form a vertical surface area with straight and angled panels for displays at trade shows, join panels together to similarly form screens for notice boards or display boards in art galleries, schools, retail outlets, cinemas, hospitals, factories, warehouses and universities, join panels together to form privacy screens between desks in office areas, join panels together to form light reflective screens in photographic studios, join low panels together to form pedestrian directional walkways, join low or fun shaped panels together to form play circles in nursery schools, construction of garage closets, storage boxes, temporary ticket booths, dolls houses, garden sheds and the like, form display pedestals for sculpture, flower arrangements, featured products, build support bases for display tables, countertops, exhibition tables or benches, suspend overhead signage or create floor stands to hold signboards and advertizing material, temporary kiosks and screens and barriers for outdoor markets and fairs, etc

The range of use of the embodiments of the invention is only limited by one's imagination. Furthermore, since the thickness of the material being clamped may range from 0.0625 inch to 1.5 inches, the range of materials may comprise glass, masonite sheets, plywood, particle board, hollow core doors, “gator” foamboard, wire or expanded metal mesh, etc. Other embodiments of the invention may clamp material with larger thickness for different applications. Since each C or U channel side of the hinged clamp embodiments is independently adjusted, any of these materials may be used together in the same assembly. The manner of use and the recommended number of clamps may vary, depending upon the use and desired effect.

The embodiments of the invention may be made of different materials. In one example, the C or U channels may be manufactured from extruded aluminum, zinc, steel, stainless steel, metal alloys, plastics, etc. Some embodiments of the invention may be made with folds for strengthening, reinforced plastic, nylon, polycarbonate, or other similar materials. The strength and appearance of the embodiments of the invention may vary based on the material used in manufacture. In one example, a threaded shaft for the hinge may be made of steel with a steel end plate, of zinc, made entirely of reinforced plastic, or other similar materials. The diameter of the threaded clamp shaft for the embodiments of the invention may be increased in size to take up most of the width of the right-angled leg of the C or U channel. In this embodiment of the invention, the larger diameter of the threaded shaft may have the effect of eliminating a moving clamp plate attached to the shaft end as the larger diameter of the threaded shaft is, in itself, a large gripping surface.

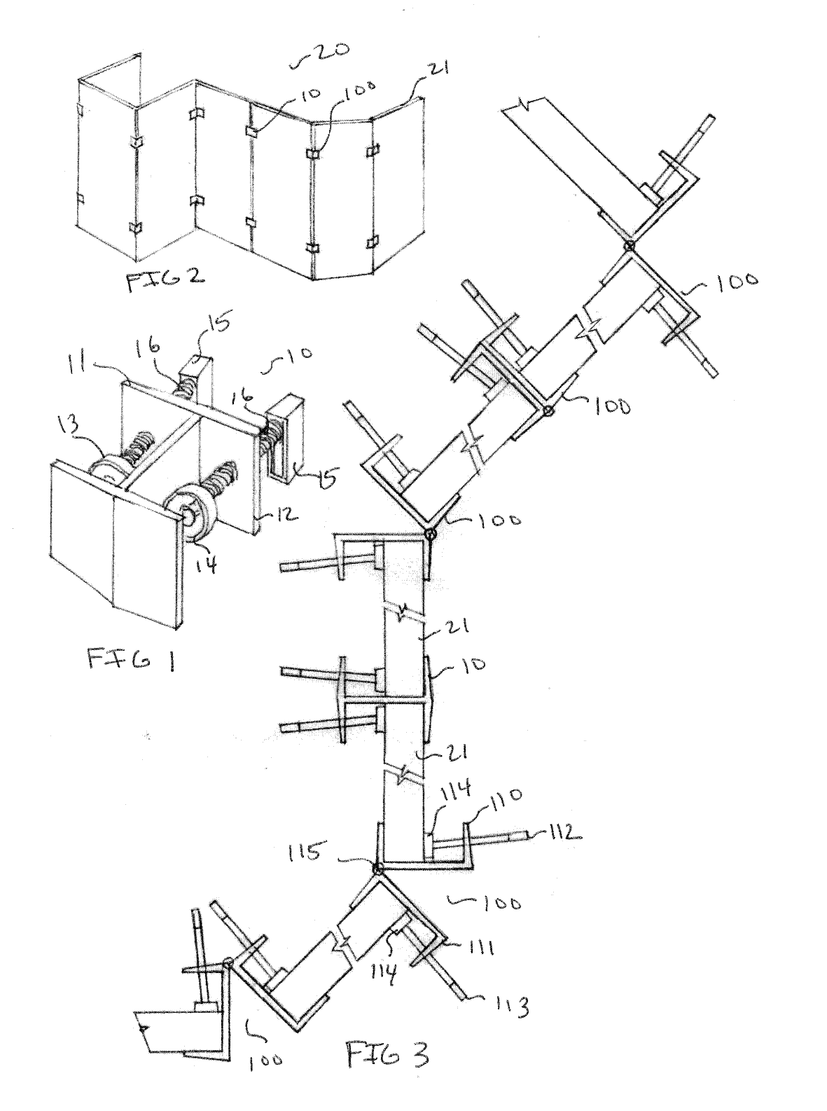

FIG. 1 illustrates a perspective view of a fixed double C or U shaped clamp 10 according to one embodiment of the invention. In one embodiment of the invention, the fixed double clamp 10 includes upper and lower tapered end portions 11 and 12, clamp plates 13 and 14 that are attached to adjusting clamp screws 16 and turn handles 15. In one example, the fixed double clamp 10 may hold two panels edge to edge in a straight line.

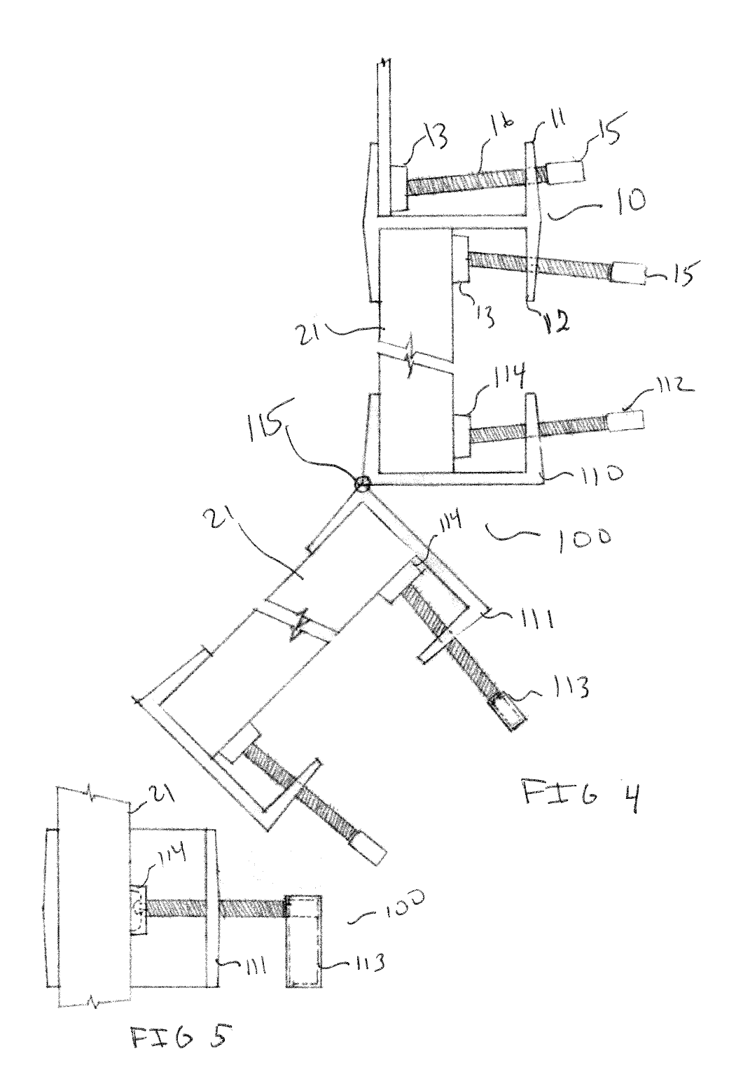

FIG. 2 illustrates a multi panel system 20 using the double clamp 10 shown in FIG. 1 and a hinged double C or U shaped clamp 100 according to one embodiment of the invention. As shown, multiple panels 21 are joined together to form various desired shapes based on the angle selected for the hinged double clamp 100.

FIG. 3 illustrates a top view of a panel system using fixed double clamps 10 and hinged double clamps 100 to join panels 21 together according to one embodiment of the invention. As shown, a chained panel system may be formed using various combined angles for joining panels 21 together. In one embodiment of the invention, the hinged double clamp 100 includes hinge 115 including a hinge pin/screw 116 (FIG. 7) that may be turned for increasing friction between the opposing ends of the clamp sides joined by the hinge 115 to maintain an angle between the opposite sides 110 and 111 of the hinged clamp 100. Clamp plate 114 is forced into contact with the panel 21 via the clamp screw 16 being turned to tighten against the panel 21 via the clamp screw grip portion 112/113.

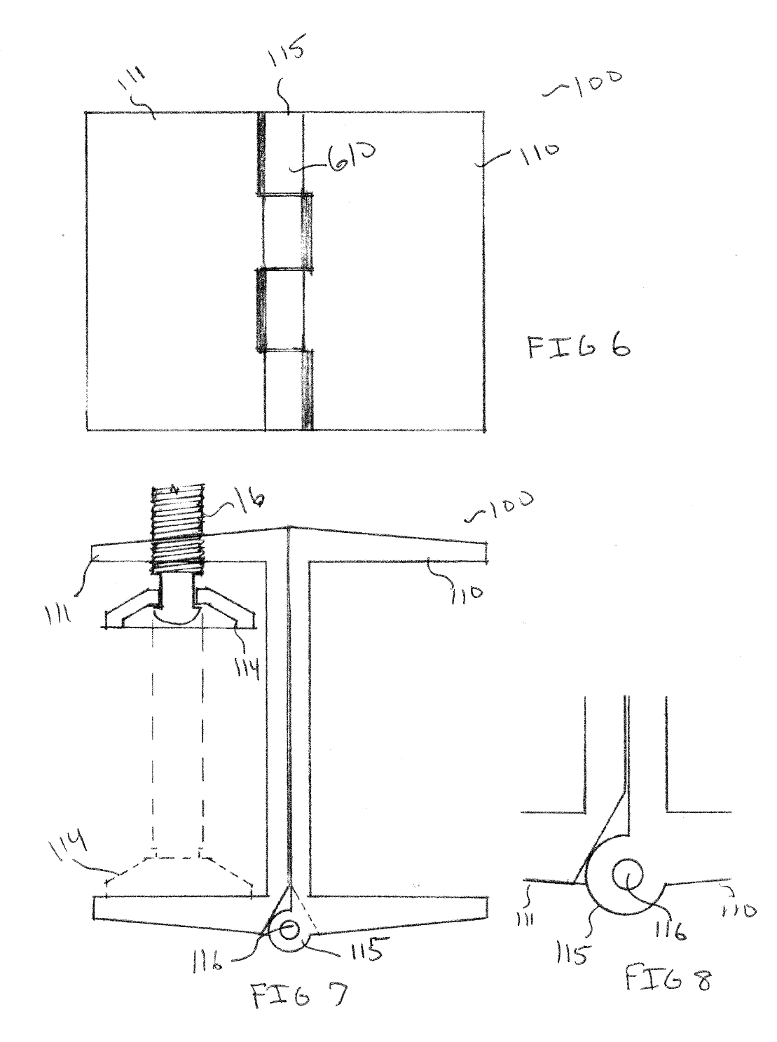

FIG. 4 illustrates an enlarged top view of a hinged double clamp 100 and a fixed double clamp 10 used together for connecting panels 21 according to one embodiment of the invention. As shown, panels 21 of different thicknesses may be joined together due to the adjustability of the clamp screw 16 with clamp plate 13. In one example, since the ends of clamp sides 11/12 and 110/111 are tapered, in one example the clamp screw 16 is angled towards the corner of the opposing end of clamp sides 11/12 and 110/111 for holding a panel 21. FIG. 5 illustrates a side view of one side of a hinged double clamp 100 according to one embodiment of the invention.

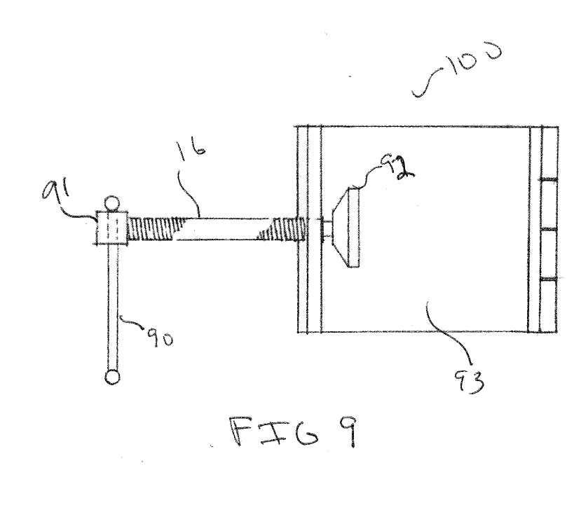

FIG. 6 illustrates a front view of a hinged double clamp 100 according to one embodiment of the invention. As shown, the sides 110 and 111 of the double clamp 100 each include hinge segments 610 formed with the hinge 115 that integrate with each other and are kept together with a hinge pin/screw 116 (FIG. 7).

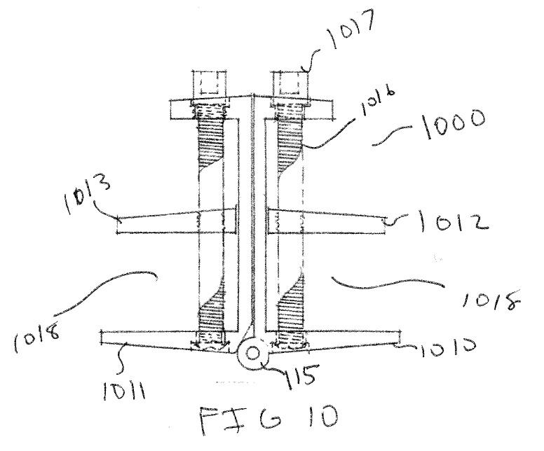

FIG. 7 illustrates a top view of a hinged double clamp 100 according to one embodiment of the invention. As shown, the clamp plate 114 is adjustable based on the clamp screw 16. FIG. 8 illustrates an isolated view of the hinge 115 for a double clamp 100 according to one embodiment of the invention. As shown, the hinge pin/screw 116 is centered within the hinge 115.

FIG. 9 illustrates a side view of a hinged double clamp 100 using a standard clamp tightening screw 16 with a lever 90 according to one embodiment of the invention. In one example, the lever 90 slides within the lever housing 91 so that it may be turned from wither side of the lever housing 91 to adjust the standard clamp plate 92 within the clamp opening 93.

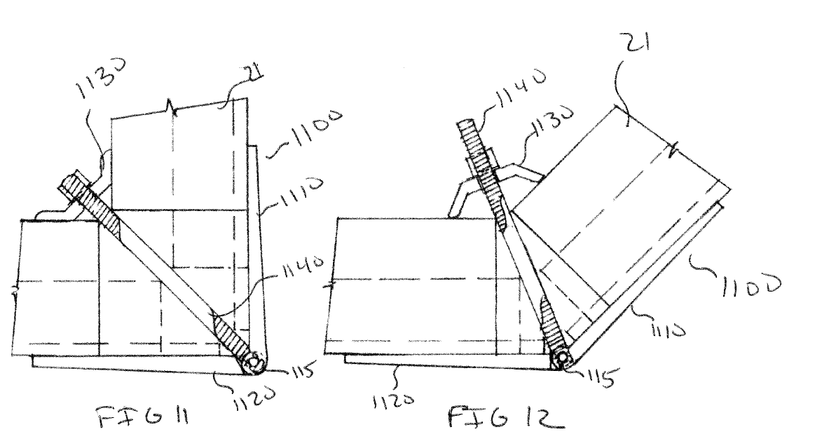

FIG. 10 illustrates a top view of a hinged double clamp 1000 according to one embodiment of the invention. As shown, the clamp screws 1016 are fixed within the clamp sides 1010 and 1011. In one example, when the clamp screw 1016 is turned via the key receptacle 1017, the clamp arms 1012/1013 are adjusted to clamp any item/panel that resides within the clamp openings 1018.

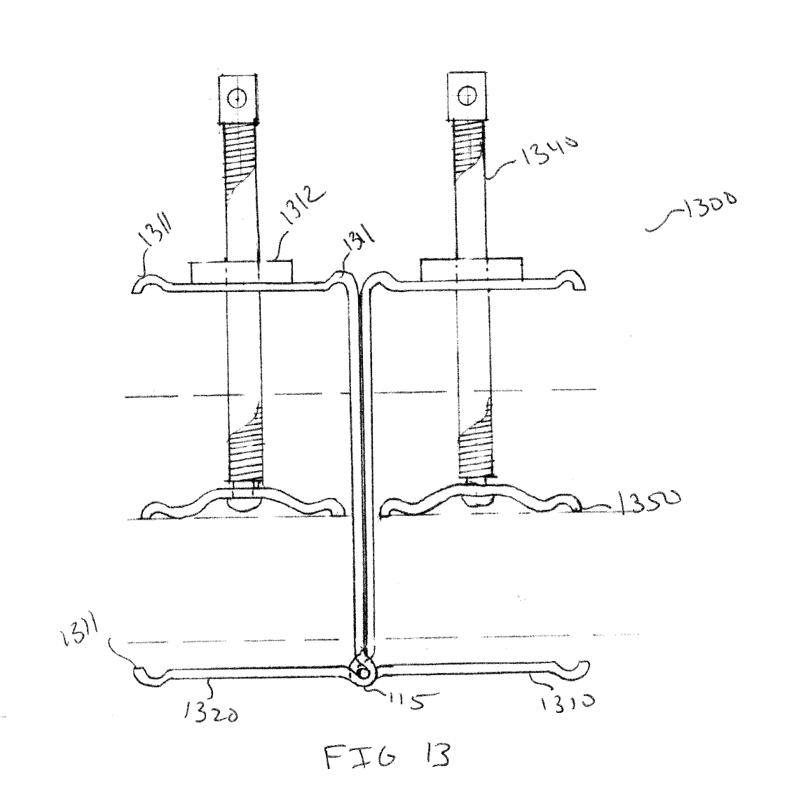

FIG. 11 illustrates a top view of a hinged double clamp 1100 shown holding panels 21 at a right angle according to one embodiment of the invention. FIG. 12 illustrates a top view of the hinged double clamp 1100 shown in FIG. 11 holding panels 21 at another angle. In one embodiment of the invention, the hinge 115 provides for the adjustability of the clamp sides 1110 and 1120. As shown, the clamp adjustment arm/angled plate 1130 moves along the clamp screw 1140 for tightening the clamp onto a panel 21. The angled plate 1130 may be reversed for providing clamping of panels at 90 degrees at the outside corner (FIG. 11) or another angle (e.g., 35 degree outside corner) between panels (FIG. 12). In one example, the clamp screw 1140 is anchored to the hinge pin/screw 116 and the hinge 115 is locked at the desired angle with a threaded hole in the hinge knuckle wall with a screw tightening onto the hinge pin/screw 116.

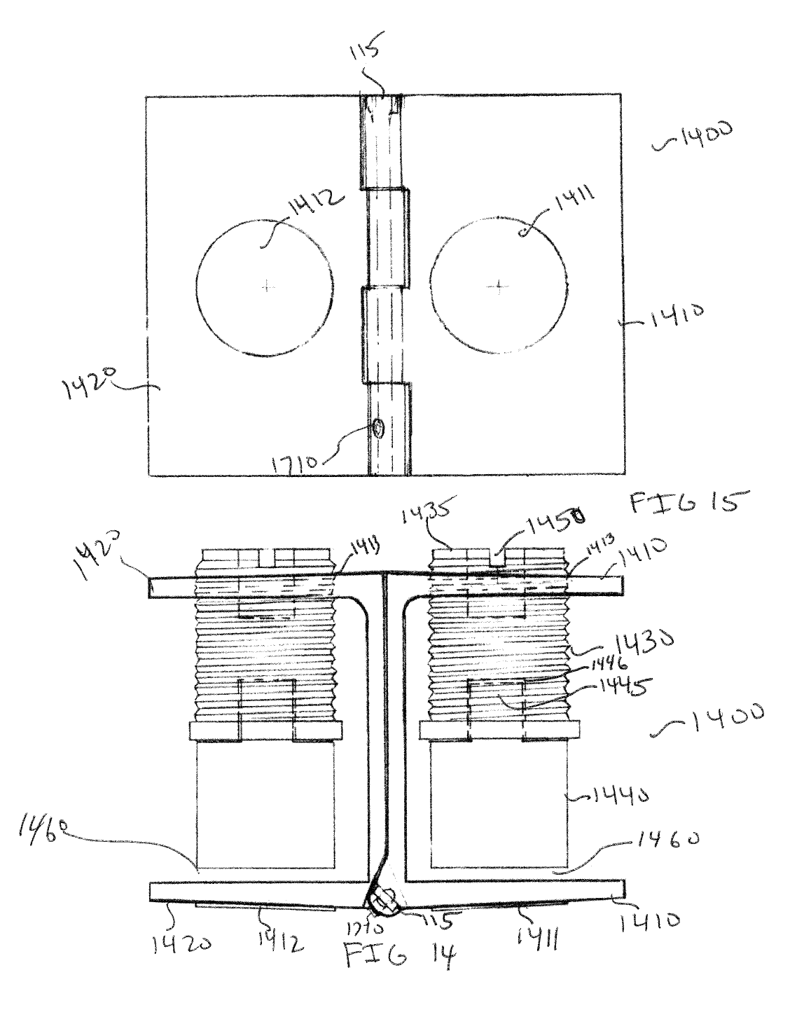

FIG. 13 illustrates a top view of a hinged double clamp 1300 according to one embodiment of the invention. In one example, the clamp sides 1310 and 1320 have rolled corners 1311 for added strength. In one example a metal washer 1312 may be welded to the clamp screw leg 1340 to provide sufficient screw thread depth. In one embodiment of the invention, the clamp plate 1350 includes a rolled end portion for added strength.

FIG. 14 illustrates a top view of a hinged clamp 1400 including a clamping screw device 1430 according to one embodiment of the invention. In one example, the clamping screw device may include an extension element 1440 that includes a coupling portion 1445 that fits into a slot 1446 within the clamping screw 1430 body. In one example, the clamping screw 1430 includes a key portion 1450 on the bottom 1435 of the clamping screw 1430. The key portion 1450 may include a recessed hexagonal socket for turning the clamping screw 1430 for adjusting its height within the clamp opening 1460. In another example, the key portion 1450 includes a slot 1470 (FIG. 16) for allowing a coin or flat metal section to be used to turn the clamping screw 1430.

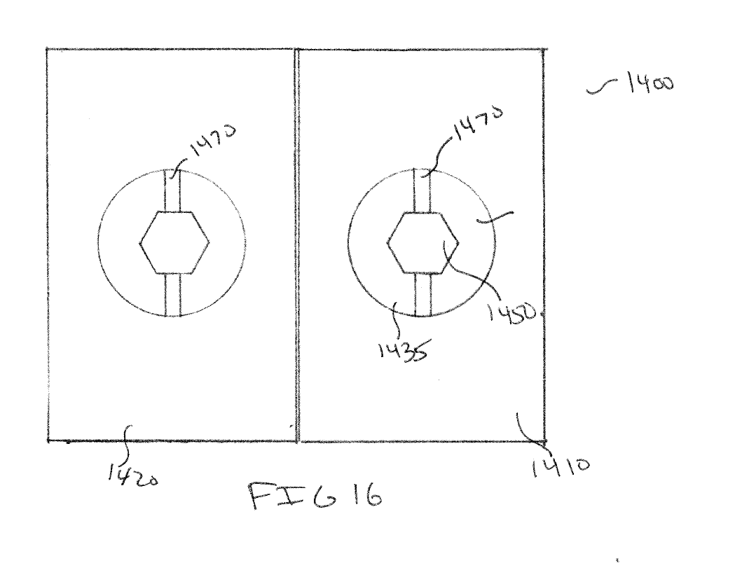

The hinged double clamp 1400 includes pairs of tapered sides 1410 and 1420. In one embodiment of the invention, the opposing tapered sides 1410 and 1420 may be slightly angled towards one another. This results in a thickened corner at the junction of the sides 1410 and 1420 and the base of the C or U channels. This thickened corner improves the resistance to upward bending of the sides 1410 and 1420 when pressure is applied by tightening the clamping screws 1430. The clamping screws 1430 have a large diameter so that a clamp plate is not necessary in order to hold a panel. In one example, the front of the hinged double clamp 1400 includes circular raised portions 1411 and 1412. Since the double clamps of the hinged double clamp 1400 may be used to join panels 21 with the clamping screws 1430 facing both the front and the back in the same assembly of panels, these raised portions 1411 and 1412 are provided as an aesthetic and balancing element to match the clamping screw faces 1435. In another embodiment of the invention, the circular raised portions 1411 and 1412 are applied decals. In one embodiment of the invention a friction element 1710 is provided for adding friction to increase or decrease the ease with which the clamp sides 1410 and 1420 may be angled. In one embodiment of the invention, tightening the friction element 1710 substantially locks the position of the desired angle. FIG. 15 illustrates a front view of the hinged clamp 1400 shown in FIG. 14 according to one embodiment of the invention. FIG. 16 illustrates a rear view of the hinged clamp 1400 shown in FIG. 14 according to one embodiment of the invention.

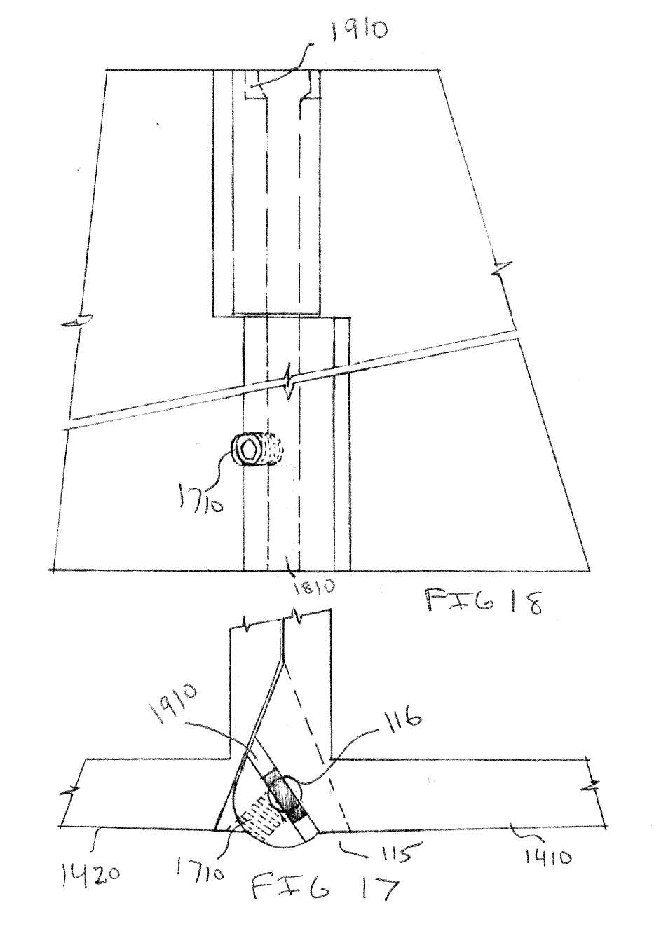

FIG. 17 illustrates an isolated top view of the hinge 115 according to one embodiment of the invention. As shown, the friction element 1710 abuts the hinge pin/screw 116. In one example, when the friction element 1710 is screwed inward against the hinge pin/screw 116, the force provides friction against the hinge pin/screw 116 and increases the force necessary to move the tapered sides 1410 and 1420 in relation to the hinge 115. When the friction element 1710 is screwed away from the hinge pin/screw 116, the friction is reduced allowing ease of motion of the tapered sides 1410 and 1420 in relation to the hinge 115. In one example, the top of the hinge pin/screw 116 is flattened to fit into a slot 1910.

FIG. 18 illustrates an isolated front view of the hinge 115 showing the friction element 1710 that enters the hinge pin/screw channel 1810 according to one embodiment of the invention. The hinge pin/screw 116 is flattened at the top. The slot 1910 holds the top of the hinge pin/screw 116 in place and the combination of this top fixing and the bottom friction element 1710 provides the friction control.

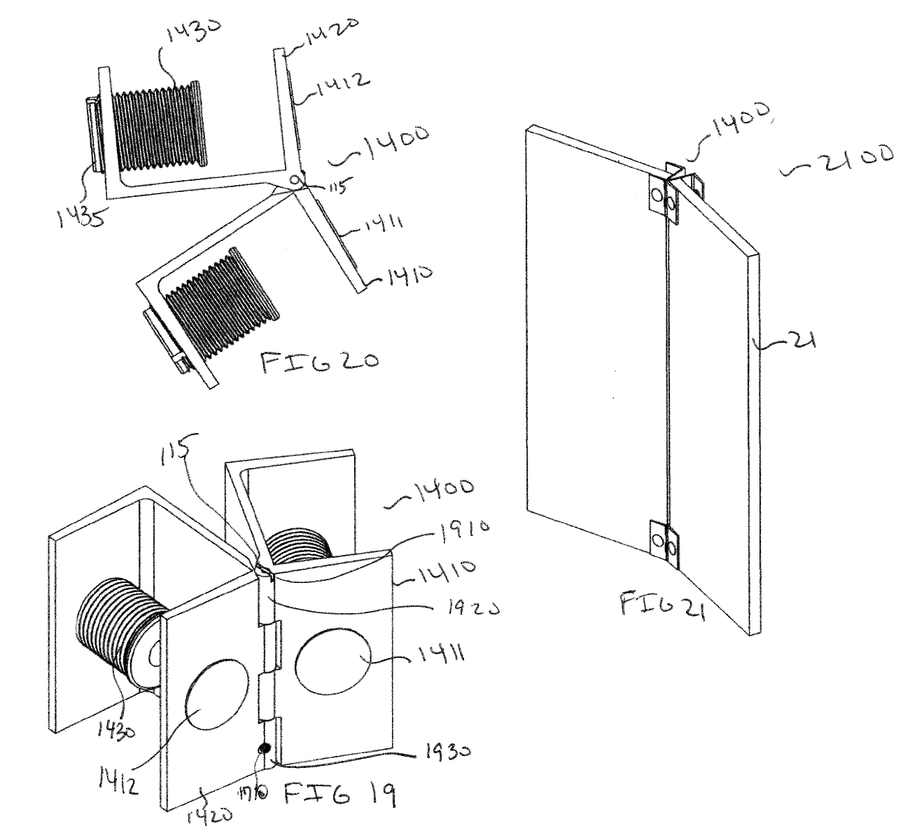

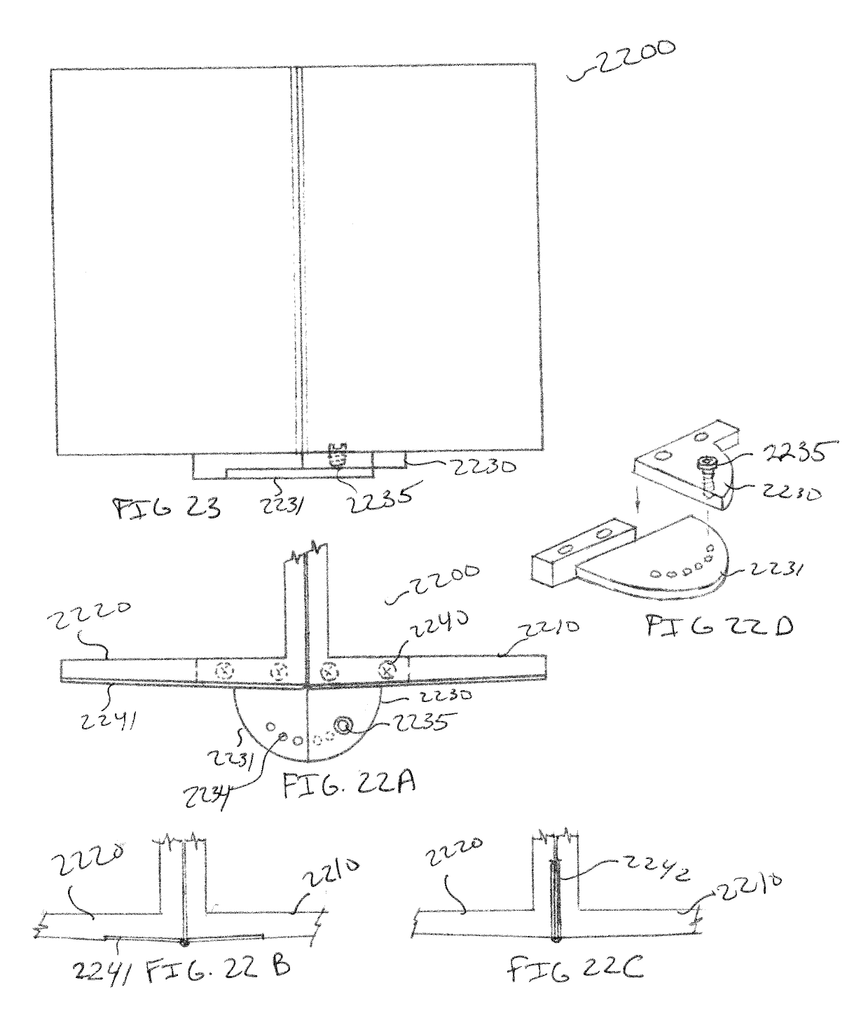

FIG. 19 illustrates a perspective view of the hinged double clamp 1400 according to one embodiment of the invention. In one example, the top of the hinge pin/screw 116 is flattened to fit into a slot 1910 in the top knuckle 1920 of the hinge 115. In one embodiment of the invention, the friction element 1710 is disposed in the bottom knuckle 1930 for providing tightening placement of the tapered sides 1410 and 1420 at any desired angle in relation to the hinge 115. FIG. 20 illustrates a top view of the hinged double clamp 1400 shown in FIG. 19 according to one embodiment of the invention.

FIG. 21 illustrates two panels 21 connected together using hinged double clamps 1400 according to one embodiment of the invention. The number of hinged double clamps 1400 that are used for connecting these two panels 21 is dependant on the height and weight of the panels 21 and additional clamps can be used and positioned in any desired positions along the junction of the panels 21.

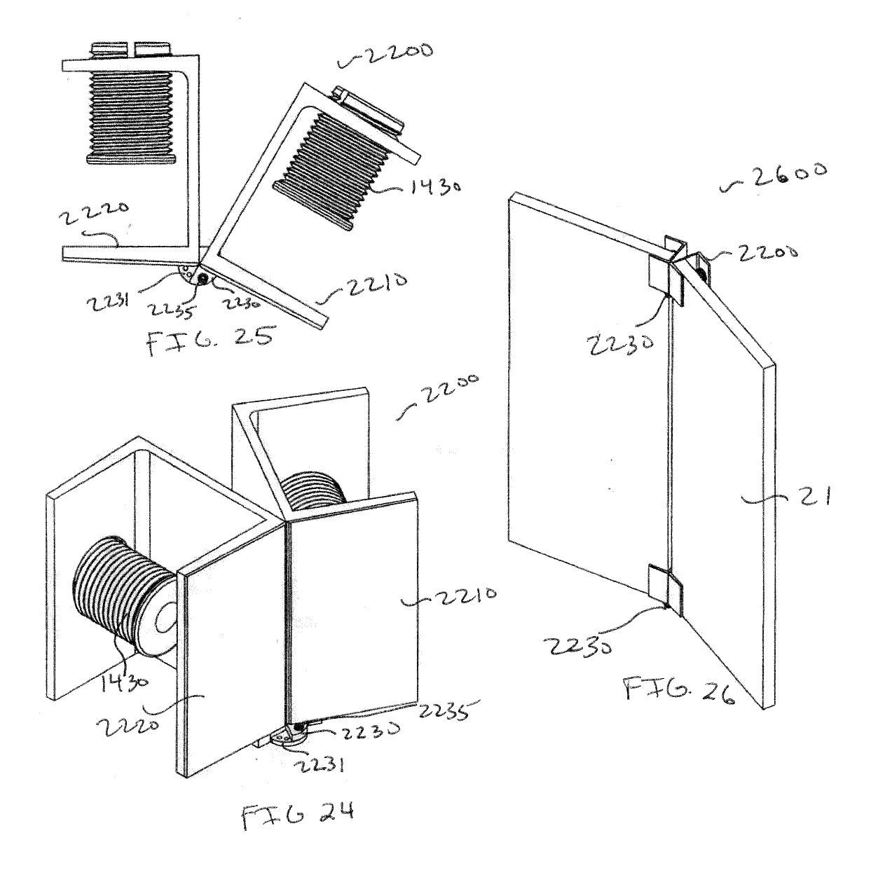

FIG. 22A illustrates a top view of a hinged double clamp 2200 with a friction plate 2230 according to one embodiment of the invention. FIG. 22D illustrates an isolated view of the friction plate 2230 shown in FIG. 22A. The quarter circle friction plate 2230 is fixed by screws 2240 into the underside of side 2210 and rotates on top of a semi-circular portion 2231 that is fixed by screw 2240 into the underside of side 2220. The quarter-circle plate 2230 holds a threaded screw 2235 and the semi-circular plate 2231 includes a plurality of holes in a radial pattern to receive the underside of the screw 2235. In one example, the sides 2210 and 2220 are placed at a desired angle in relation to one another. The screw 2235 is then tightened into an opening 2234 to lock the angle between the sides 2210 and 2220 in place.

FIGS. 22B-C illustrate another embodiment of the invention that includes a thin sheet of plastic 2241 with good flexibility and strength, such as polypropylene or other similar material, is fixed with a suitable adhesive to cover the complete front or hinge face of the hinged double clamp 2200 forming a hinge. In one example a narrow strip of plastic 2242 may be incorporated and fixed to the face of the hinged double clamp plates 2220 and 2210, or as illustrated in FIG. 22C folded and fixed into the inside faces at the junction of the sides 2210 and 2220 to form the hinge. At the junction of the two sides 2210 and 2220, a vertical thinning is created in the plastic and creates what is commonly referred to as a “living hinge.” This example eliminates the need for complex cutting and drilling to form the knuckled hinge with a hinge pin and its assembly etc.

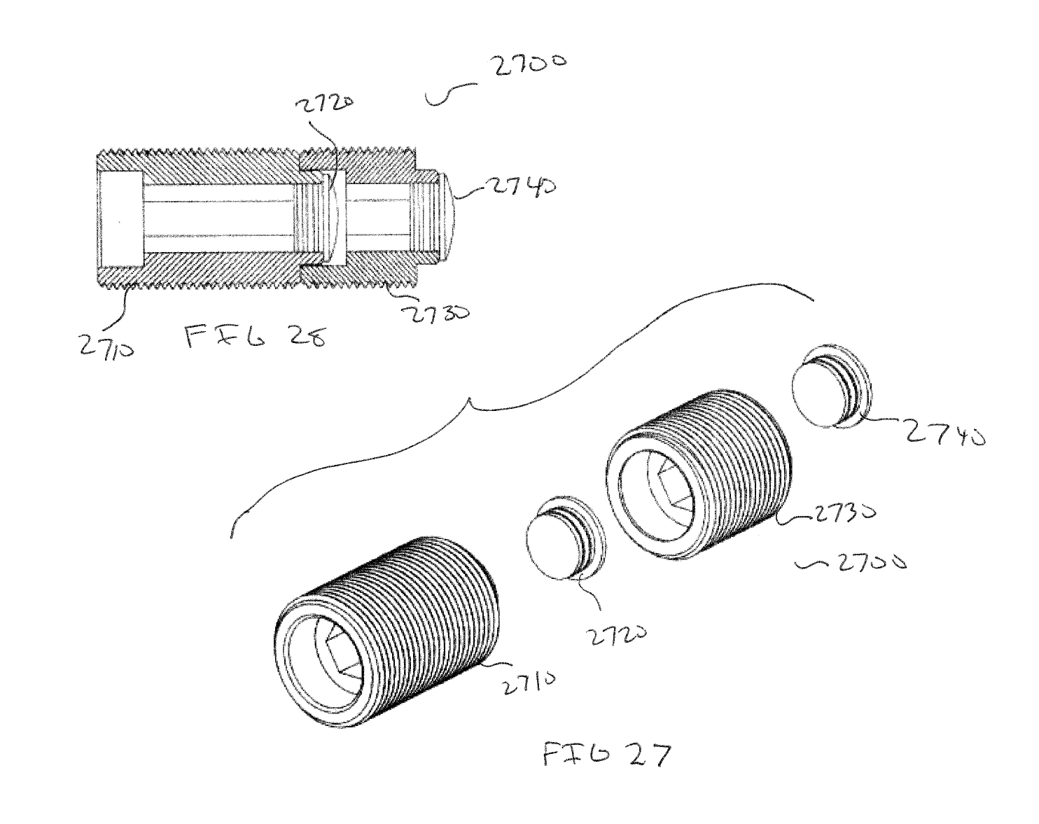

FIG. 23 illustrates a front view of the hinged double clamp 2200 with the friction plate 2230 shown in FIG. 22A according to one embodiment of the invention.

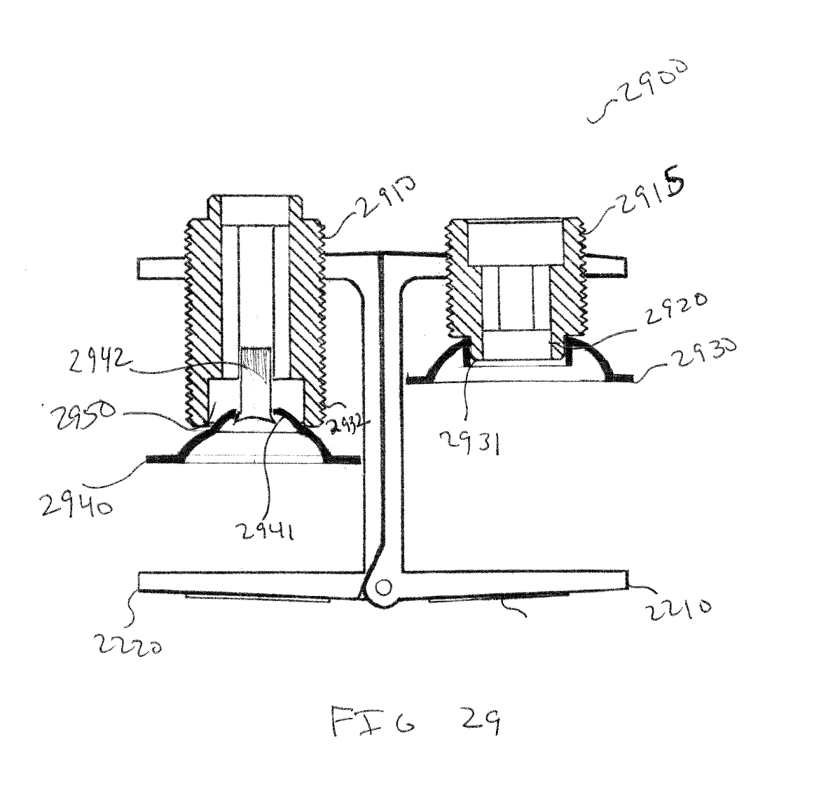

FIG. 24 illustrates a perspective view of the hinged double clamp 2200 with the friction plate 2230 shown in FIG. 22 according to one embodiment of the invention. FIG. 25 illustrates a top view of the hinged double clamp 2200 with the friction plate 2230 shown in FIG. 22 according to one embodiment of the invention. FIG. 26 illustrates two panels 21 connected together using hinged double clamps 2200 with friction plates 2230 according to one embodiment of the invention.

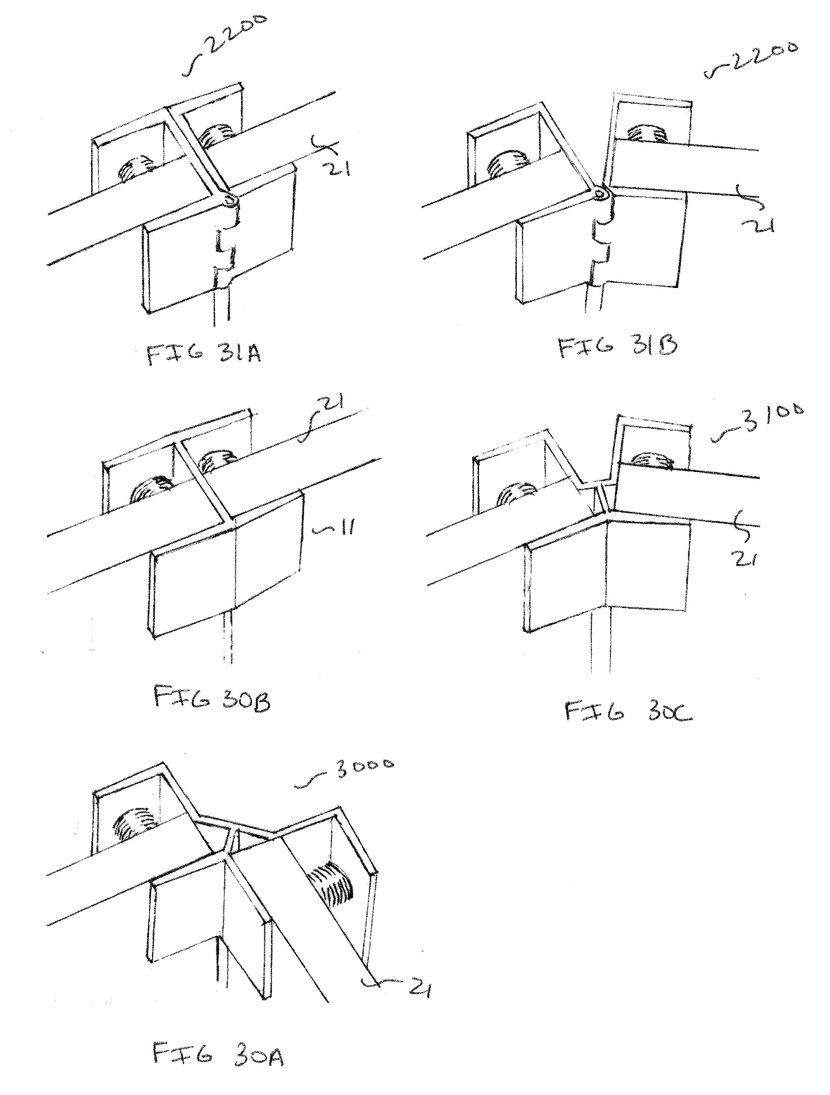

FIG. 27 illustrates an exploded view of components of an extendable clamp screw 2700 according to one embodiment of the invention. In one example, the clamp screw 2700 includes a long clamp screw 2710, a long screw plug 2720, a short clamp screw 2730 and a short screw plug 2740. In one embodiment of the invention, the short clamp screw 2730 may be coupled onto the long clamp screw 2710 for clamping thinner panels. For clamping thicker panels, the short clamp screw 2730 or the long clamp screw 2710 may be used separately, depending on the thickness of the panel to be clamped. In one example only the short clamp screw 2730 may be required when a thick panel, such as a flush panel door is clamped, while both the long clamp screw 2710 and the short clamp screw 2730 may be interconnected for clamping a thin sheet, such as a 0.25 inch plywood panel or a 0.0625 inch sheet of steel. Use of the short screw plug 2740 and the long screw plug 2720, which may be made of plastic or rubber, provides a better friction hold and also a more cushioned clamping for softer material when this is required. The long screw plug 2720 and the short screw plug 2740 are inserted into the front end of the long clamp screw 2710 and the front end of the short clamp screw 2730.

In one example, the clamp screw 2700 results in a hinged double clamp being suitable for use both in temporary and in permanent installations. In one example, the front ends of the short and long clamp screws 2730 and 2710 are accordingly designed to receive the short screw plug 2740 and the long screw plug 2720 while retaining the interconnectivity of the long clamp screw 2710 and the short clamp screw 2730. FIG. 28 illustrates a cross section of the extendable clamp screw 2700 according to one embodiment of the invention.

FIG. 29 illustrates a top view of a hinged double clamp 2900 with a clamp cup 2940 attached to a long clamp screw 2910 and a clamp cup 2930 attached to a short clamp screw 2915 according to one embodiment of the invention. As with the extendable clamp screw 2700, the short clamp screw 2915 may couple with the long clamp screw 2910 for clamping thinner panels in the hinged double clamp 2900. In one example, the clamp cups 2930 and 2940 enhance the surface area of a friction grip (e.g., when the hinged double clamp 2900 is used with softer panels made of material, such as softboard, etc.). In one example, the short clamp plug 2740 and the long clamp plug 2720 may be removed and the larger dome shaped clamp cups 2930 and 2940 may be attached to the ends of the short clamp screw 2915 or the long clamp screw 2910.

In one embodiment of the invention, the clamp cup 2940 includes a tapered portion 2941 and a vertical pin portion 2942 that is configured to fit within the long clamp screw 2910 (or the short clamp screw 2915, not shown). In another embodiment of the invention, the clamp cup 2930 includes a gap 2920 configured to fit over an end 2931 of a short clamp screw 2915 (or a long clamp screw 2910, not shown). As shown, both the long clamp screw 2910 and the short clamp screw 2915 may be screwed into the clamp sides having the openings for the clamp screws 2910 and 2915 with either the narrow end of the clamp screw 2931 first or the wide end of the clamp screw 2932 first, or vice versa. This also enhances the flexibility for adjusting the screw projections and the range of thicknesses of panels or material that may be clamped by the double hinged clamp 2900.

FIGS. 30A-C illustrate perspective views of fixed double clamps without hinges according to some embodiment of the invention. FIG. 30A shows a fixed double clamp 3000 is configured for clamping panels 21 together at a 90 degree angle. FIG. 30B shows a fixed double clamp 11 is configured for clamping panels 21 together at a 180 degree angle. FIG. 30C shows a fixed double clamp 3100 is configured for clamping panels 21 together at a 45 degree angle. It should be noted that other embodiments of the invention may be configured for joining panels 21 at additional angles (e.g., 30 degrees, 60 degrees, etc.).

FIGS. 31A-B illustrate perspective views of hinged double clamps 2200 according to some embodiment of the invention. FIG. 31A shows two panels 21 joined at a 180 degree angle by a hinged double clamp 2200. FIG. 31B shows two panels 21 joined at about a 45 degree angle by a hinged double clamp 2200. By using the hinged double clamps 2200, any angles between 180 degrees to approximately 60 degrees are possible.

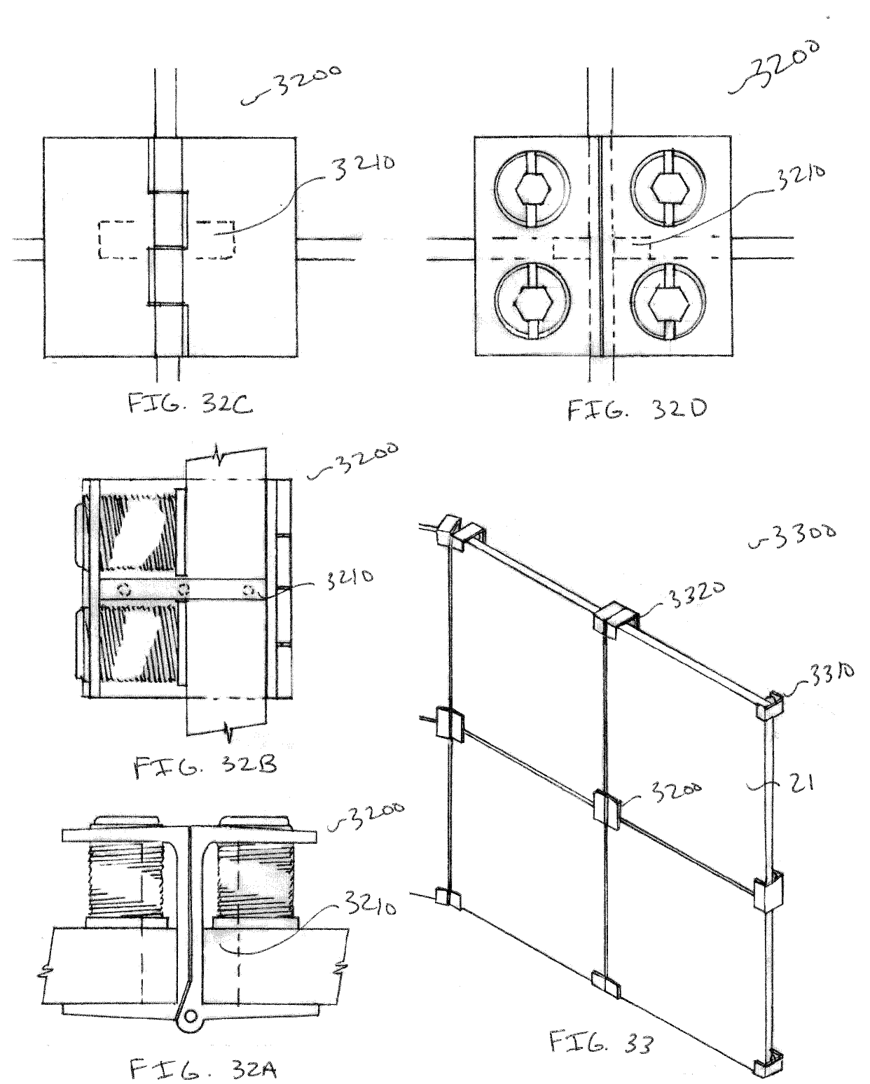

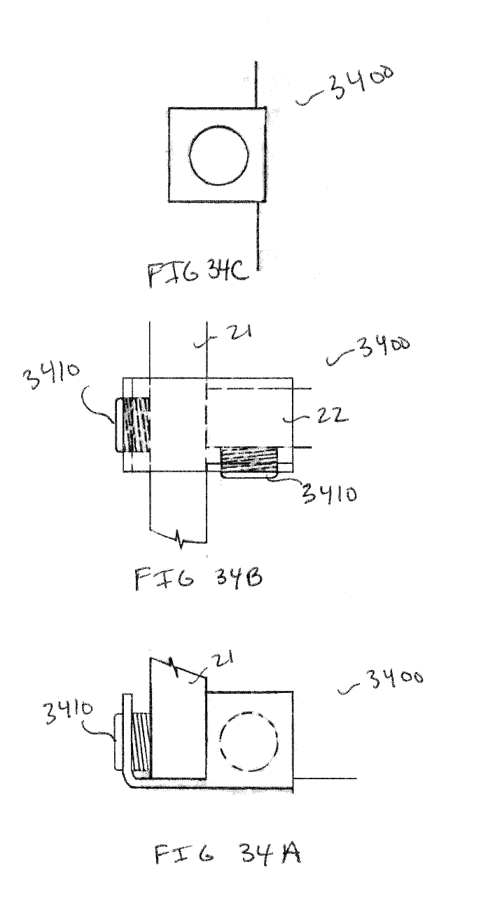

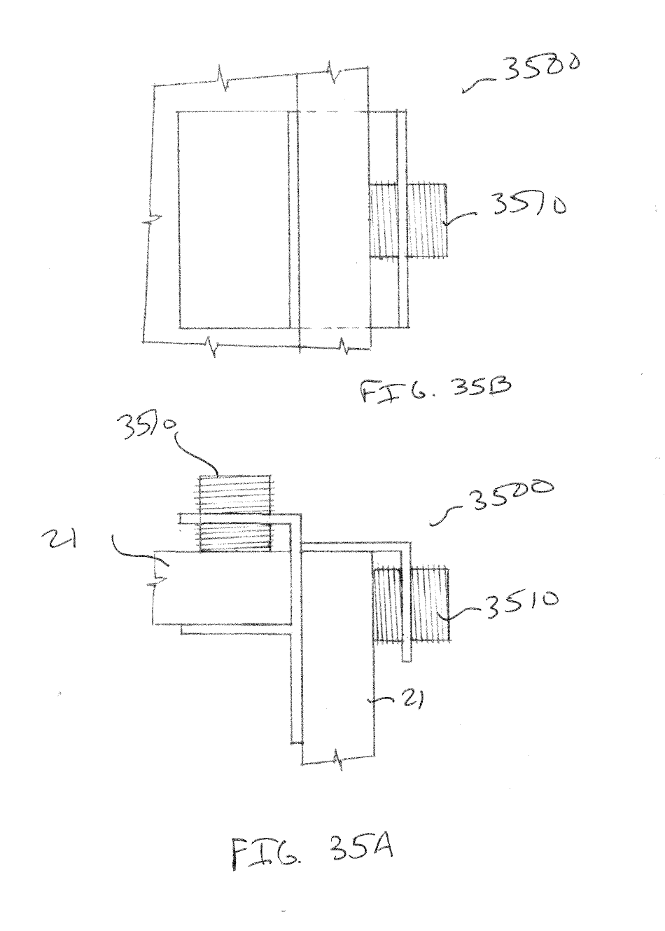

FIGS. 32A-D illustrate views of hinged double clamps 3200 having a cross-bar 3210 to provide support for panel corners according to one embodiment of the invention. In one example, the addition of a shelf or cross bar 3210 joined to and running horizontally across the center of each U channel of the hinged double clamp 3200, and then arranging two threaded clamp screws to each U channel, a four-way clamp is created where four panels 21 may be joined at the corners.

FIG. 33 illustrates multiple panels 21 connected with hinged double clamps 3200 and other types of clamps according to one embodiment of the invention. As shown, quarter clamps 3310 are used on the ends of the panel 21 sections. Half clamps 3320 are used at upper and lower middle sections of the panel 21 configuration.

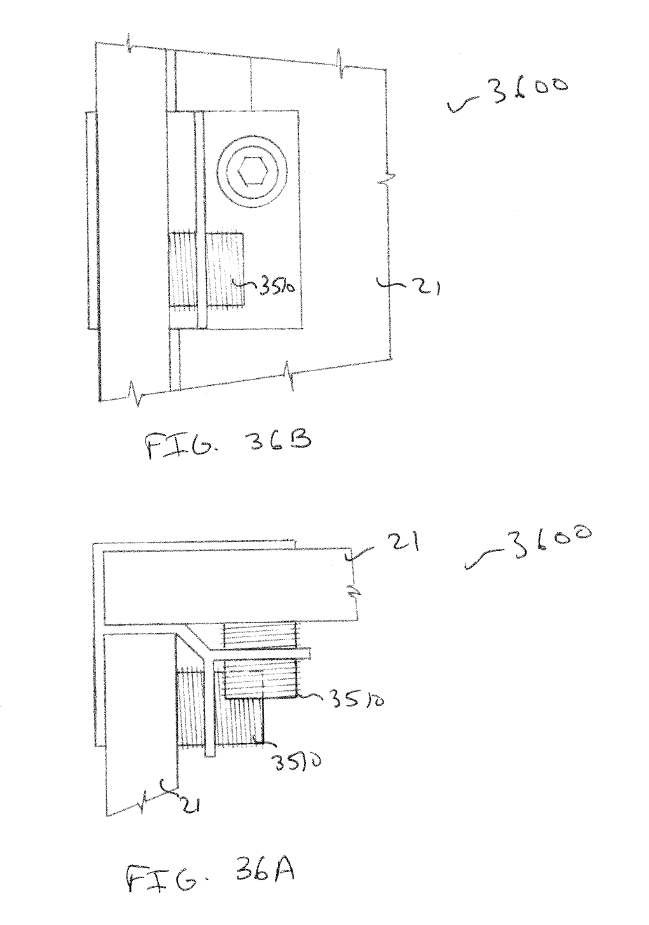

FIGS. 34A-C illustrate views of double clamps 3400 for joining panels horizontal to vertical according to one embodiment of the invention. In one example, the double clamp 3400 creates a junction between a vertical panel 21 and a horizontal panel 22, used for example to create a book case. The double clamp 3400 would be most suitable for use where the panel 21 material thickness is constant so that the double clamp 3400 is small (as compared to hinged double clamps) and only short clamp screws 3410 may be used, resulting in considerable manufacturing cost savings.

FIGS. 35A-B illustrate views of an offset double clamp 3500 according to one embodiment of the invention. In one example, a 90 degree clamped corner connection is configured to allow for an overlap of the panels 21 at the corner and provides a clean inside 90 degree bend, while still using threaded screws 3510 similar to clamp screws 2700 for clamping.

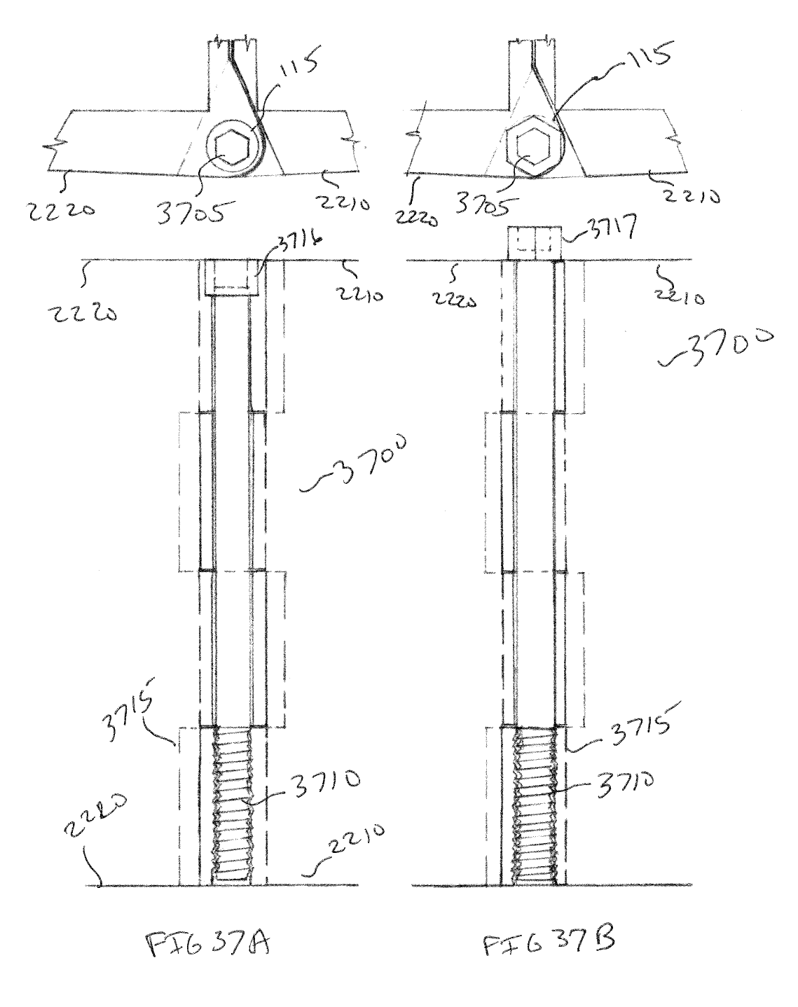

FIGS. 36A-B illustrate views of an offset double clamp 3600 with a clean outer 90 degree bend according to one embodiment of the invention. In one example, double clamp 3600 provides for an overlapped 90 degree connectivity between panels 21. As illustrated, the clamp screws 3510 are offset vertically to allow for the overlap between the clamp screws 3510. In one example, double clamp 3600 may be specifically used for panels 21 having similar thicknesses to avoid large vertical gaps that would appear if variable thickness panels 21 are joined.

FIGS. 37A-B illustrate views of a friction screw 3700 system for tightening hinged double clamps at particular angles according to one embodiment of the invention. In one example, the bottom quarter of the hinge screw 3710 is threaded and the bottom knuckle of the hinge 3715 is tapped. When screwing the hinge screw 3710 into the bottom knuckle 3715 of the hinge the knuckles of the hinge 115 are compressed against one another and the pressure is distributed across the surface area of three knuckle joints for providing a firm and easily controlled method to increase or decrease the mobility of the hinge 115. The top 3716 of the hinge screw 3710 is recessed into the top knuckle.

In another embodiment of the invention, the head 3705 on the top 3717 of the hinge screw 3710 is hex shaped and rides on top of the hinge 115 for providing easier accessibility to the hinge screw 3710 in case of jamming by over tightening. The head 3705 has the same allen-key recess for controlling the turning pressure. In one example, if locked control is desired for any angle setting the cylindrical contacting surfaces of the knuckles may be grooved radially with the topmost point of the grooves slightly rounded. Control is provided by loosening of the hinge 115 with the allen-key, setting the desired angle and then tightening the hinge 115 with the allen key. The radiating grooves interlock and provide a locked angle position.

The above mentioned embodiments may include other features as follow. A thin non skid pad, such as rubber, emery cloth, etc. may be adhered to the inside face of each clamp side (e.g., 2210, 2220) opposite the clamp screw face (e.g., the face of clamp screw 2700) for enhancing friction hold on panels 21. The inside face of the clamp sides (e.g., 2210, 2220) may also be scored or designed with a pattern of fine protruding lines to improve grip.

The embodiments of the invention maintain the gap between two edge to edge clamped panels 21 to a minimum by maintaining the base of each C or U-shaped clamp section to a minimum wall thickness. In one embodiment of the invention, the panels 21 that are being held by the clamp embodiments may be notched to fit over the clamp wall thickness so that the panels 21 would then touch at their edges with virtually no gap between panels, which may be more appropriate for permanent installations. Other embodiments of the invention allow panels to be reused and to be changed as required without any damage to the panels due to notching.

The above-mentioned embodiments of the invention result in a clamp product for assembling panels easily and quickly, and inexpensively, but still give a clean aesthetically pleasing result with wide ranging versatility of use of clamping varied material thicknesses.

In the description above, numerous specific details are set forth. However, it is understood that embodiments of the invention may be practiced without these specific details. For example, well-known equivalent components and elements may be substituted in place of those described herein, and similarly, well-known equivalent techniques may be substituted in place of the particular techniques disclosed. In other instances, well-known structures and techniques have not been shown in detail to avoid obscuring the understanding of this description.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. An apparatus comprising:
a first clamp device including a first opening; and
a second clamp device coupled to the first clamp device, the second clamp device including a second opening;
wherein a first adjustable element is coupled through the first opening, and a second adjustable element is coupled through the second opening.

2. The apparatus of claim 1, wherein the first clamp device and the second clamp device are coupled via a hinge.

3. The apparatus of claim 2, wherein the hinge is coupled with a locking device for fixing a coupling angle between the first clamp device and the second clamp device.

4. The apparatus of claim 3, wherein the locking device is disposed within the hinge.

5. The apparatus of claim 1, wherein the first adjustable element comprises a first removably coupled extension element, and the second adjustable element comprises a second removably coupled extension element.

6. The apparatus of claim 5, wherein the first clamp device comprises a first C-clamp device and the second clamp device comprises a second C-clamp device.

7. The apparatus of claim 6, wherein the first C-clamp device and the second C-clamp device each include a tapered holding portion.

8. The apparatus of claim 7, wherein the first C-clamp and the second C-clamp each include a gripping portion.

9. The apparatus of claim 5, wherein the first clamp device and the second clamp device are fixedly coupled to one another at an angle.

10. The apparatus of claim 9, wherein the angle is fixed at one of 30°, 45°, 60°, 90° and 180°.

11. An apparatus comprising:
a first C-clamp device coupled with a first adjustable element; and
a second C-clamp device rotatably coupled to the first C-clamp device via a hinge, the second C-clamp device coupled with a second adjustable element.

12. The apparatus of claim 11, wherein the hinge is coupled with a locking device for fixing an angle between the first C-clamp device and the second C-clamp device.

13. The apparatus of claim 12, wherein the locking device is disposed within the hinge.

14. The apparatus of claim 11, wherein the first adjustable element comprises a first removably coupled extension element, and the second adjustable element comprises a second removably coupled extension element.

15. The apparatus of claim 11, wherein the first C-clamp device and the second C-clamp device each include a tapered holding portion.

16. A system comprising:
a first C-clamp device coupled with a first adjustable clamping element;
a lockable hinge coupled to the first C-clamp device; and
a second C-clamp device coupled to the lockable hinge, the second C-clamp device coupled with a second adjustable clamping element.

17. The system of claim 16, wherein the first adjustable clamping element comprises a first removably coupled extension element, and the second adjustable clamping element comprises a second removably coupled extension element.

18. The system of claim 16, wherein the first C-clamp device and the second C-clamp device each include a tapered holding portion.
